(19) United States
(12) Patent Application Publication
(10) Pub. No.: US 2016/0116270 A1
(43) Pub. Date: Apr. 28, 2016

(54) DETECTING DEVICE

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventor: RONG-CHUN SU, Jiashan (CN)

(21) Appl. No.: 14/614,626

(22) Filed: Feb. 5, 2015

(30) Foreign Application Priority Data
Oct. 22, 2014 (CN) 201420612652.6

(51) Int. Cl. G01B 5/28

(52) U.S. Cl. CPC G01B 5/28

(57) ABSTRACT

A detecting device for detecting damage to a blade includes a transmission mechanism and a conducting mechanism engaged with the transmission mechanism. The transmission mechanism includes a transmission member, a sliding member coupled to the transmission member, and a support base. The conducting mechanism includes a contacting member and a cable. The transmission member includes a pressing portion and a threaded rod connected to the pressing portion. The blade resists against the pressing portion to move the threaded rod toward the sliding member. The sliding member slidingly cooperates with the support base and presses against the contacting member, and the cable can transmit an electrical signal when the blade is in non-operative state.

### FIELD

The subject matter herein generally relates to a detecting device, and particularly to a detecting device configured for detecting damage to a machine blade.

### BACKGROUND

Workpieces are usually made of metal materials, such as iron, aluminum, or magnesium alloys, and are frequently machined using a blade. The blade may be broken due to the aging, or meeting a super hard material. If the broken blade is not replaced in time, the processing quality of the workpieces by the broken blade will be lower.

### BRIEF DESCRIPTION OF THE DRAWINGS

Implementations of the present technology will now be described, by way of example only, with reference to the attached figures.

FIG. 1 is an isometric view of an embodiment of a detecting device, a blade, and a holder.

FIG. 2 is an isometric view of the detecting device of FIG. 1.

FIG. 3 is an exploded, isometric view of the detecting device of FIG. 2.

FIG. 4 is an isometric view of the detecting device of FIG. 2 without a protective cover.

FIG. 5 is a cross-sectional view of the detecting device taken along line V-V of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a detecting device.

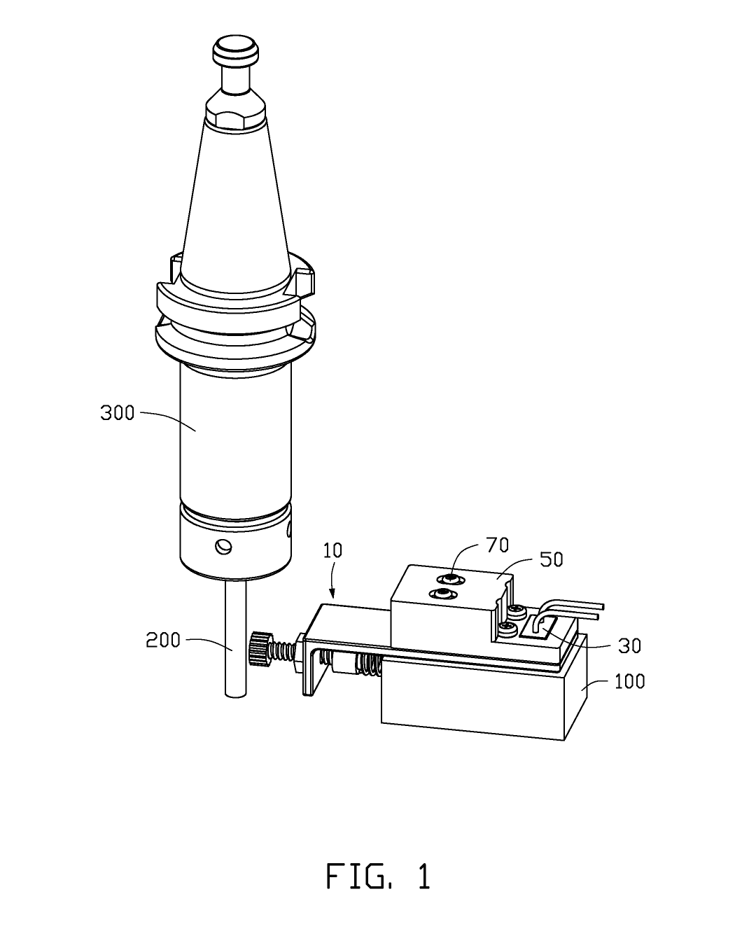

FIG. 1 illustrates an isometric view of an embodiment of a detecting device 100, a blade 200, and a holder 300. The blade 200 can be assembled to the holder 300, and the detecting device 100 can be configured for detecting damage to the blade 200.

The blade 200 can be perpendicular to the detecting device 100, and the holder 300 moves the blade 200 toward the detecting device 100. A sidewall of the blade 200 can be engaged with the detecting device 100. In other embodiments, the blade 200 can be perpendicular to the detecting device 100, and a free end (not shown) of the blade 200 can be engaged with the detecting device 100.

The detecting device 100 can include a transmission mechanism 10, a conducting mechanism 30 assembled to the transmission mechanism 10, a protective cover 50 covering the conducting mechanism 30, and a plurality of bolts 70. The transmission mechanism 10 can be configured to contact the blade 200. An outside driving member (not shown) can move the blade 200 toward the transmission mechanism 10, and the transmission mechanism 10 can be compressed by the blade 200 toward the conducting mechanism 30 unless the blade 200 is unbroken. Then the conducting mechanism 30 can transmit an electrical signal about the unbroken blade 200 to an operator. In the illustrated embodiment, the distance S that the transmission mechanism 10 travels can be greater than 3.5 mm, and less than 10 mm. Then the conducting mechanism 30 transmits an electrical signal that the blade is unbroken. The diameter of the blade 200 can be greater than 0.5 mm.

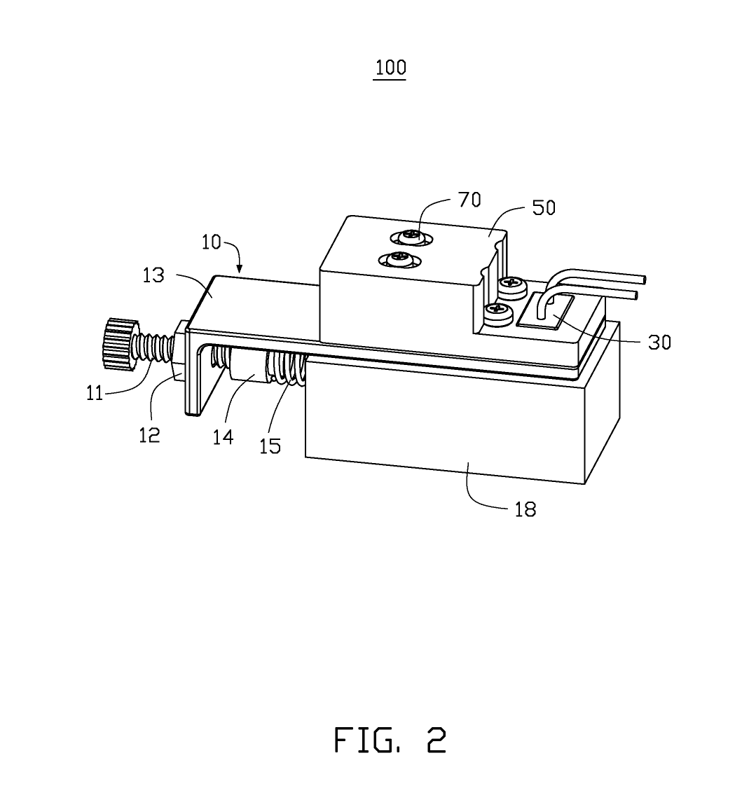

FIG. 2 illustrates an isometric view of the detecting device 100. The transmission mechanism 10 can include a transmission member 11, a fastening member 12, a bracket 13; an assembly member 14, a first elastic member 15, and a support base 18. The transmission member 11 can pass through the bracket 13 and the fastening member 12 in turn, the assembly member 14 can be assembled to the transmission member 11, and the first elastic member 15 can elastically resist against the assembly member 14.

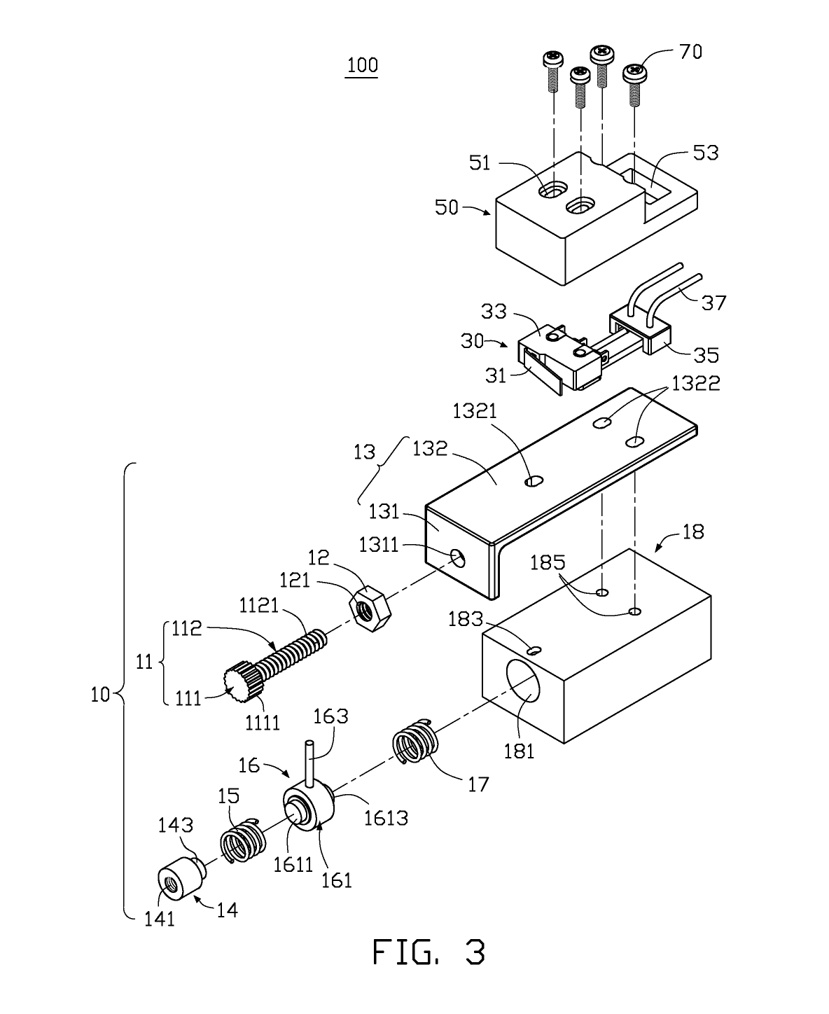

FIG. 3 illustrates an exploded, isometric view of the detecting device 100. The transmission member 11 can include a pressing portion 111 and a threaded rod 112 connected to the pressing portion 111. The blade 200 (shown in FIG. 1) can press against the pressing portion 111. A plurality of vertical threads 1111 can be spaced from each other and evenly arranged in the circumferential direction of the pressing portion 111. The threaded rod 112 can be substantially cylindrical, and connected to the assembly member 14. The threaded rod 112 can define an outer threaded portion 1121. A diameter of the pressing portion 111 can be larger than that of the threaded rod 112, to prevent the blade 200 from dropping from an end surface of the pressing portion 111.

The fastening member 12 can be substantially annular, and define an inner threaded portion 121. The inner threaded portion 121 can be coupled to the outer threaded portion 1121 of the threaded rod 112.

The bracket 13 can be substantially L-shaped, and include an engaging portion 131 and a supporting portion 132. The engaging portion 131 can be perpendicular to the supporting portion 132. The engaging portion 131 can define an opening 1311 engaged with the threaded rod 112, and the threaded rod 112 can pass through the opening 1311. The supporting portion 132 can define a first through hole 1321 adjacent to the engaging portion 131, and a pair of first fastening holes 1322 away from the engaging portion 131.

The assembly member 14 can include a connecting portion 141 and a protuberance 143, and the connecting portion 141 can be substantially a hollow cylinder. The connecting portion 141 can be coupled to the outer threaded portion 1121 of the threaded rod 112, and an outer diameter of the protuberance 143 can be less than that of the connecting portion 141. The protuberance 143 can be received in the first elastic member 15, and the first elastic member 15 can elastically press against the connecting portion 141. In other embodiments, the assembly member 14 and the threaded rod 112 can be formed integrally, and the pressing portion 111 and the threaded rod 112 can be two separate elements coupled together.

The first elastic member 15 can be substantially a hollow cylinder, and a diameter of the first elastic member 15 can be equal to that of the protuberance 143. The protuberance 143 can be received in the first elastic member 15, and the first elastic member 15 can abut the connecting portion 141.

The transmission mechanism 10 can further include a sliding member 16 and a second elastic member 17 assembled to the support base 18, and the second elastic member 17 can be same as the first elastic member 15. The sliding member 16 can be elastically sandwiched between the first elastic member 15 and the second elastic member 17.

The sliding member 16 can include a main body 161 and an extending portion 163 vertically connected to the main body 161. The main body 161 can include a first end portion 1611 and a second end portion 1613, and the first end portion 1611 and the second end portion 1613 can be symmetrically defined on two end surfaces of the main body 161. The first end portion 1611 can be engaged to the first elastic member 15, and the second end portion 1613 can be engaged to the second elastic member 17. The extending portion 163 can extend perpendicularly from the main body 161. The extending portion 163 can be substantially rod-shaped, and a diameter of the extending portion 163 can match that of the first through hole 1321. The extending portion 163 can be exposed beyond the first through hole 1321.

The support base 18 can be fastened below the supporting portion 132 and include a receiving portion 181, a second through hole 183, and a pair of second fastening holes 185. The sliding member 16 and the second elastic member 17 can be received in the receiving portion 181, the second through hole 183 can be diametrically opposite to the first through hole 1321, and the pair of second fastening holes 185 can be respectively corresponding to the pair of first fastening holes 1322. A size of the receiving portion 181 can match that of the second elastic member 17, and a size of the second through hole 183 can match that of the extending portion 163. In operation, the extending portion 163 can run through the second through hole 183 and the first through hole 1321 in turn, and the extending portion 163 can slidingly cooperate with the second through hole 183 and the first through hole 1321.

The protective cover 50 can be ladder-shaped, configured to protect the conducting mechanism 30 from contaminants. A size of the protective cover 50 can match that of the conducting mechanism 30. The protective cover 50 can include a pair of third fastening holes 51 and a rectangular receiving hole 53. In the illustrated embodiment, the bolts 70 can be engaged to the third fastening holes 51, to fasten the protective cover 50 on the bracket 13.

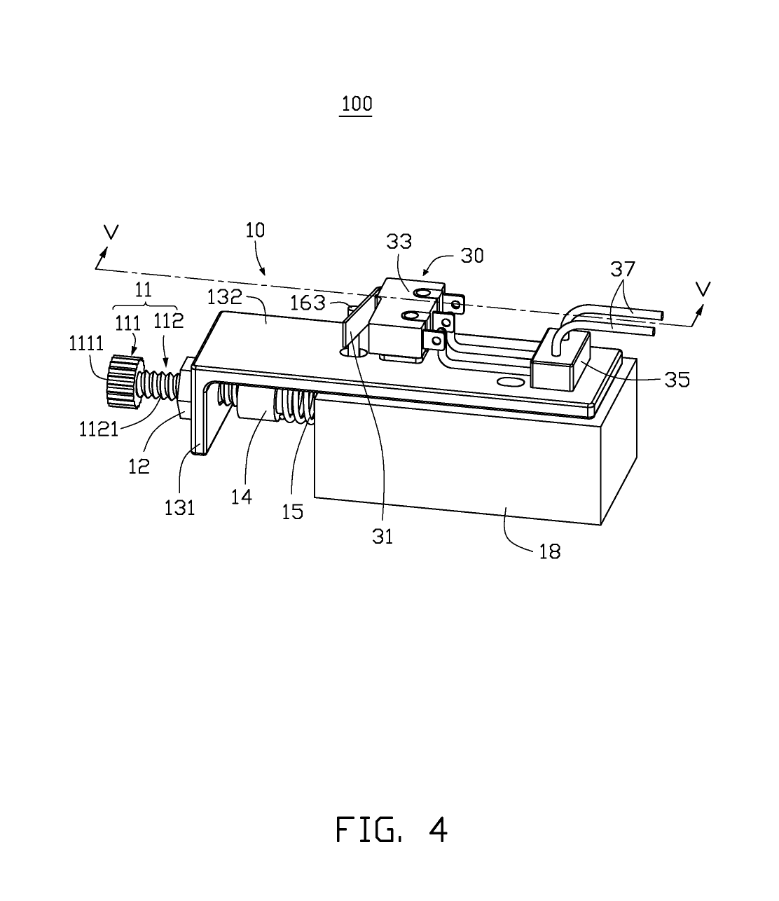

FIG. 4 illustrates an isometric view of the detecting device 100 without the protective cover 50 (shown in FIG. 3). The conducting mechanism 30 can include a contacting member 31, a first fastening block 33 connected to the contacting member 31, a second fastening block 35, and a cable 37 electrically connected to the first fastening block 33. The contacting member 31 can have elasticity, and can be engaged with the extending portion 163. The second fastening block 35 can be received in the receiving hole 53 (shown in FIG. 3). The cable 37 can extend away from the second fastening block 35, and can be electrically connected to an outside display device (not shown). The cable 37 can be configured to transmit an electrical signal when the blade 200 is in non-operative state.

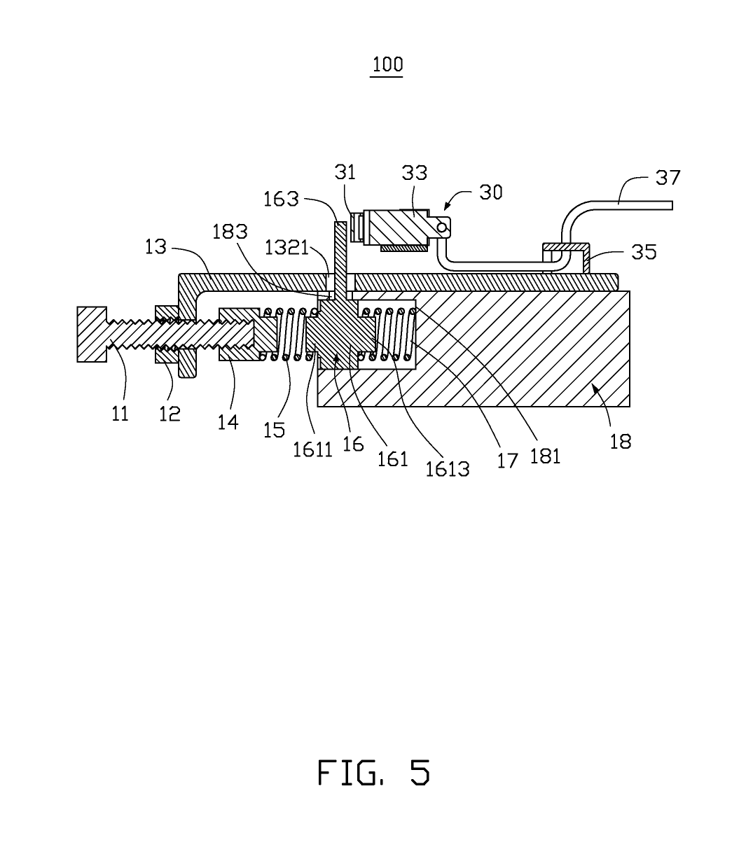

FIG. 5 illustrates a cross-sectional view of the detecting device 100 without the protective cover 50 (shown in FIG. 3). In operation, the blade 200 (shown in FIG. 1) can move the transmission member 11 toward the conducting mechanism 30 by an outside driving member (not shown). Simultaneously, the assembly member 14 can be pressed toward the first elastic member 15, and the first elastic member 15 can be compressed. The sliding member 16 can move toward the contacting member 31 along the first through hole 1321, and the second elastic member 17 can be compressed. The extending portion 163 can contact the contacting member 31, and the conducting mechanism 30 can transmit an electrical signal to the outside display device. An operator can determine if the blade is broken, according to the outside display device.

The blade 200 can be oriented away from the transmission member 11 after being detected. The second elastic member 17 can be released, and the sliding member 16 can be moved against spring tension of the second elastic member 17. Then the extending portion 163 can be away from the contacting member 31, the first elastic member 15 simultaneously expands. If the blade 200 is broken, the conducting mechanism 30 cannot transmit an electrical signal to the outside display device, and the workpiece will not be machined by the broken blade 200.

The detecting device 100 can have a conducting mechanism 30 and a transmission mechanism 10 engaged to the conducting mechanism 30. The blade 200 can press against the transmission member 11 of the transmission mechanism 10, when the blade 200 is unbroken. Then the extending portion 163 can contract the contacting member 31, and the conducting mechanism 30 can transmit an electrical signal that the blade 200 is unbroken. The blade 200 cannot press against the transmission member 11 of the transmission mechanism 10, when the blade 200 is broken. Simultaneously, the conducting mechanism 30 cannot work normally, and an operator can determine that the blade 200 is broken. Therefore the detecting device 100 can detect whether the blade 200 has broken down, before the workpieces are machined. Further, a processing quality of the workpieces can be improved.

The embodiments shown and described above are only examples. Many details are often found in the art such as the other features of a detecting device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A detecting device for detecting damage to a blade, the detecting device comprising:
a transmission mechanism comprising
a transmission member,
a bracket surrounding the transmission member,
a sliding member partially exposed beyond the bracket, and coupled to the transmission member,
a support base connected to the bracket,
a first elastic member elastically sandwiched between the transmission member and the sliding member, and
a second elastic member elastically sandwiched between the sliding member and the support base; and
a conducting mechanism operatively engaged with the transmission mechanism comprising:
a contacting member, and
a cable configured to transmit an electrical signal when the blade is in non-operative state;
wherein the transmission member comprises a pressing portion and a threaded rod connected to the pressing portion, the blade resists against the pressing portion; and
wherein the sliding member slidingly cooperates with the support base and presses against the contacting member.

2. The detecting device as claimed in claim 1, wherein the transmission mechanism further comprises an assembly member engaged with the threaded rod, and the assembly member elastically resists against the first elastic member.

3. The detecting device as claimed in claim 2, wherein the assembly member comprises a connecting portion and a protuberance connected to the connecting portion, an outer diameter of the protuberance is less than that of the connecting portion, and the protuberance is received in the first elastic member.

4. The detecting device as claimed in claim 1, wherein the threaded rod defines an outer threaded portion.

5. The detecting device as claimed in claim 1, wherein the transmission mechanism further comprises a fastening member surrounding the threaded rod; and the fastening member defines an inner threaded portion, and the inner threaded portion is coupled to the outer threaded portion of the threaded rod.

6. The detecting device as claimed in claim 1, wherein the bracket is substantially L-shaped, and comprises an engaging portion and a supporting portion; and the engaging portion is perpendicular to the supporting portion.

7. The detecting device as claimed in claim 6, wherein the engaging portion defines an opening engaged with the threaded rod, and the threaded rod passes through the opening.

8. The detecting device as claimed in claim 7, wherein the supporting portion defines a first through hole adjacent to the engaging portion, and the support base comprises a second through hole diametrically opposite to the first through hole.

9. The detecting device as claimed in claim 8, wherein the sliding member comprise a main body and an extending portion vertically connected to the main body; and the extending portion is exposed beyond the first through hole and the second through hole.

10. The detecting device as claimed in claim 9, wherein the main body comprises a first end portion and a second end portion; and the first end portion and the second end portion are symmetrically defined on two end surfaces of the main body.

11. The detecting device as claimed in claim 10, wherein the first end portion is engaged to the first elastic member, and the second end portion is engaged to the second elastic member.

12. The detecting device as claimed in claim 1, wherein the support base further comprises a receiving portion; and the sliding member and the second elastic member are received in the receiving portion.

13. The detecting device as claimed in claim 1, wherein the conducting mechanism further comprises a first fastening block connected to the contacting member and a second fastening block; and the cable extends away from the second fastening block.
